(19) United States
(12) Patent Application Publication
(10) Pub. No.: US 2003/0035165 A1
(43) Pub. Date: Feb. 20, 2003

(54) System and apparatus for photonic switching

(76) Inventor: Bruce A. Schofield, Tyngsboro, MA (US)

Correspondence Address: BROMBERG & SUNSTEIN LLP, NORTEL NETWORKS LIMITED, 600 TECHNOLOGY PARK DRIVE, MS E65-60-403, BILLERICA, MA, 01821, US

(21) Appl. No.: 09/929,582

(22) Filed: Aug. 14, 2001

(51) Int. Cl. H04J 14/00; H04J 14/02

(52) U.S. Cl. 359/117; 359/128

(57) ABSTRACT

A system and apparatus for photonic switching combines photonic add/drop multiplexing capabilities with photonic cross-connect switching capabilities. The photonic switch is coupled to a number of incoming fibers and to a number of outgoing fibers. Each incoming fiber is fed into a demultiplexer that demultiplexes the incoming optical signal into its component optical data streams. The demultiplexed optical data streams from each incoming fiber are fed into a corresponding drop-only fabric, which, for each demultiplexed optical data stream, either drops or passes the optical data stream. The passed optical data streams from the various drop-only fabrics are fed into a number of input ports of a photonic cross-connect switch. The photonic cross-connect switch switches each optical data stream from an input port to an output port. The signals from a number of output ports are combined to form an outgoing optical signal, which is sent over an outgoing fiber. New optical data streams can be added through either the photonic cross-connect switch or through combiners external to the photonic cross-connect switch.

### CROSS-REFERENCE TO RELATED APPLICATION(S)

The present application may be related to the following commonly owned United States patent application, which is hereby incorporated herein by reference in its entirety:

U.S. patent application Ser. No. 09/740,706 entitled SYSTEM AND APPARATUS FOR DROPPING AND ADDING OPTICAL DATA STREAMS IN AN OPTICAL COMMUNICATION NETWORK, filed on Dec. 19, 2000 in the name of Bruce A. Schofield.

### FIELD OF THE INVENTION

The present invention relates generally to optical networking, and more particularly to photonic switching.

### BACKGROUND OF THE INVENTION

In an optical communication network, an optical data stream is typically produced by modulating an optical carrier based upon a data signal. Multiple optical data streams having different wavelengths are often multiplexed onto a single optical fiber using a technique known as Wavelength Division Multiplexing (WDM). WDM allows a single optical fiber to carry multiple optical data streams.

At various nodes in the optical communication network, it is often necessary or desirable to re-route optical data streams among and between various fibers. For example, certain optical data streams from one or more incoming fibers may be passed through to one or more outgoing fibers, while other optical data streams from the incoming fiber(s) are not passed through to the outgoing fiber(s). For convenience, an optical data stream that is passed through from an incoming fiber to an outgoing fiber is referred to hereinafter as a “passed” optical data stream, while an optical data stream that is not passed through from an incoming fiber to an outgoing fiber is referred to hereinafter as a “dropped” optical data stream. Furthermore, a number of new optical data streams may be inserted onto the outgoing fiber(s). For convenience, such a new optical data stream that is inserted onto an outgoing fiber is referred to hereinafter as an “added” optical data stream.

### SUMMARY OF THE INVENTION

In accordance with one aspect of the present invention, a system and apparatus for photonic switching combines photonic add/drop multiplexing capabilities with photonic cross-connect switching capabilities. The photonic switch is coupled to a number of incoming fibers and to a number of outgoing fibers. Each incoming fiber is fed into a demultiplexer that demultiplexes the incoming optical signal into its component optical data streams. The demultiplexed optical data streams from each incoming fiber are fed into a corresponding drop-only fabric, which, for each demultiplexed optical data stream, either drops or passes the optical data stream. The passed optical data streams from the various drop-only fabrics are fed into a number of input ports of a photonic cross-connect switch. The photonic cross-connect switch switches each optical data stream from an input port to an output port. The signals from a number of output ports are combined to form an outgoing optical signal, which is sent over an outgoing fiber. New optical data streams can be added through either the photonic cross-connect switch or through combiners external to the photonic cross-connect switch.

### BRIEF DESCRIPTION OF THE DRAWINGS

In the accompanying drawings:

FIG. 1 shows an exemplary photonic switch in accordance with an embodiment of the present invention;

FIG. 2 is a schematic block diagram showing an exemplary photonic switch in which new optical data streams are added through one set of combiners that combine a plurality of switched optical data streams with a number of new optical data streams;

FIG. 3 is a schematic block diagram showing an exemplary photonic switch in which new optical data streams are added through the photonic cross-connect switch; and

FIG. 4 is a schematic block diagram showing an exemplary photonic switch in which new optical data streams are added through two sets of combiners that combine a plurality of switched optical data streams with a number of new optical data streams.

### DETAILED DESCRIPTION OF A PREFERRED EMBODIMENT

As described above, at various nodes in the optical communication network, it is often necessary or desirable to re-route optical data streams among and between various fibers. For example, certain optical data streams from one or more incoming fibers may be passed through to one or more outgoing fibers, while other optical data streams from the incoming fiber(s) are not passed through to the outgoing fiber(s). For convenience, an optical data stream that is passed through from an incoming fiber to an outgoing fiber is referred to hereinafter as a “passed” optical data stream, while an optical data stream that is not passed through from an incoming fiber to an outgoing fiber is referred to hereinafter as a “dropped” optical data stream. Furthermore, a number of new optical data streams may be inserted onto the outgoing fiber(s). For convenience, such a new optical data stream that is inserted onto an outgoing fiber is referred to hereinafter as an “added” optical data stream.

In an embodiment of the present invention, a system and apparatus for photonic switching combines photonic add/drop multiplexing capabilities with photonic cross-connect switching capabilities. For convenience, such a system and apparatus is referred to hereinafter as a photonic switch. The photonic switch can be used to build an optical network having a physical mesh topology.

The photonic switch is typically coupled to a number of incoming fibers and to a number of outgoing fibers. Each incoming fiber is fed into a demultiplexer that demultiplexes the incoming optical signal into its component optical data streams. The demultiplexed optical data streams from each incoming fiber are fed into a corresponding drop-only fabric, which, for each demultiplexed optical data stream, either drops or passes the optical data stream. The passed optical data streams from the various drop-only fabrics are fed into a number of input ports of a photonic cross-connect switch. The photonic cross-connect switch switches each optical data stream from an input port to an output port. The signals from a number of output ports are combined to form an outgoing optical signal, which is sent over an outgoing fiber. New optical data streams can be added through either the photonic cross-connect switch or through combiners external to the photonic cross-connect switch.

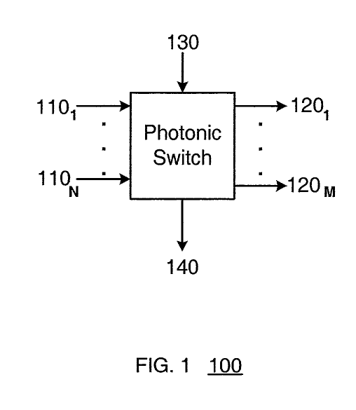

FIG. 1 shows an exemplary photonic switch 100. The photonic switch 100 is coupled to N incoming fibers 110₁-110_{N} and to M outgoing fibers 120₁-120_{M}. The photonic switch 100 is also coupled to receive new optical data streams 130 to be added to one or more of the outgoing fibers 120₁-120_{M}. The photonic switch 100 is also coupled to output any dropped optical data streams 140.

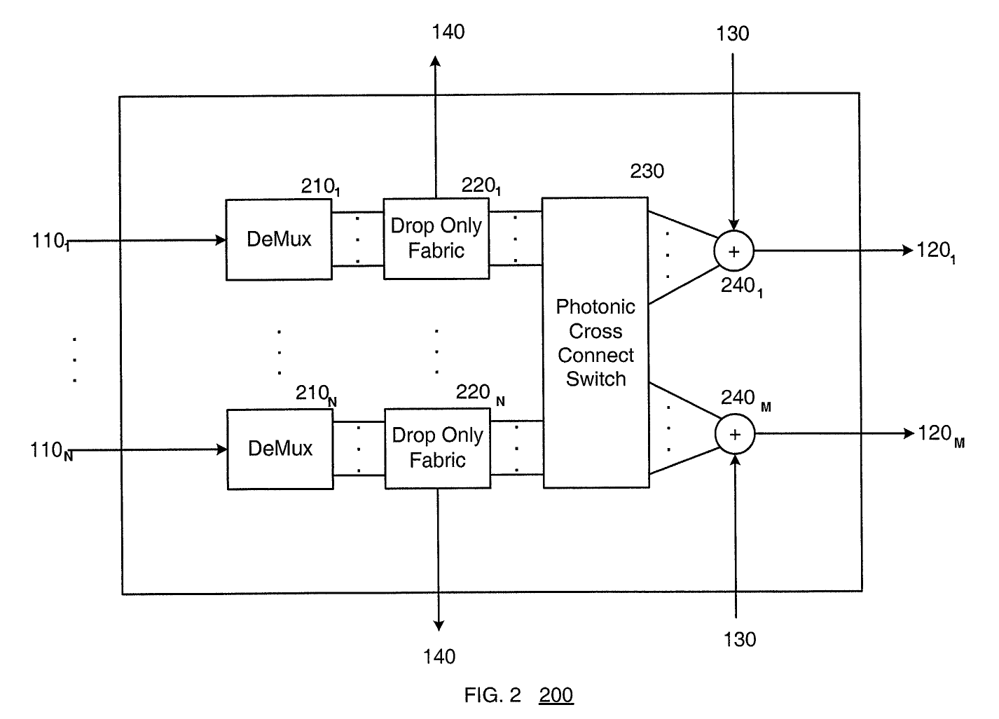

FIG. 2 is a schematic block diagram showing an exemplary photonic switch 200 in which new optical data streams are added through one set of combiners that combine a plurality of switched optical data streams with a number of new optical data streams. Among other things, the photonic switch 200 includes N demultiplexers 210₁-210_{N}, N drop-only fabrics 220₁-220_{N}, a photonic cross-connect switch 230, and M combiners 240₁-240_{M}.

The N incoming fibers 110₁-110_{N} are coupled to the N demultiplexers 210₁-210_{N}, respectively. Each demultiplexer 210 demultiplexes the incoming optical signal from the corresponding incoming fiber 110 into its component optical data streams.

The demultiplexed optical data streams from each of the N demultiplexers 210₁-210_{N} are fed into the N drop-only fabrics 220₁-220_{N}, respectively. Each drop-only fabric 220 processes the demultiplexed optical data streams received from the corresponding demultiplexer 210. Specifically, for each demultiplexed optical data stream, the drop-only fabric 220 either drops or passes the optical data stream.

The passed optical data streams from each of the N drop-only fabrics 220₁-220_{N} are fed into the photonic cross-connect switch 230. The photonic cross-connect switch 230 switches each optical data stream from an input port to an output port of the photonic cross-connect switch 230.

The switched optical data streams from the photonic cross-connect switch 230 are fed into the M combiners 240₁-240_{M}, which correspond to the M outgoing fibers 120₁-120_{M}, respectively. Any new optical data stream(s) 130 to be added to a particular outgoing fiber 120 is fed into the appropriate combiner 240. Each combiner 240 combines any optical data streams received from the photonic cross-connect switch 230 with any new optical data streams 130 and outputs the combined optical data streams over the corresponding outgoing fiber 120.

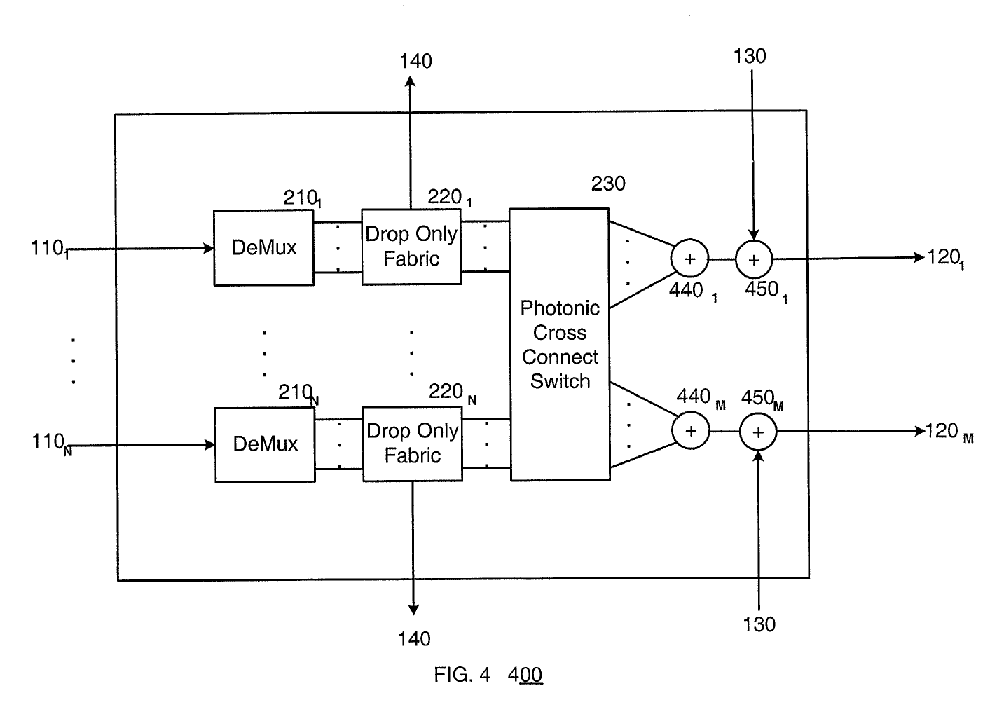

FIG. 4 is a schematic block diagram showing an exemplary photonic switch 400 in which new optical data streams are added through two sets of combiners that combine a plurality of switched optical data streams with a number of new optical data streams. Among other things, the photonic switch 400 includes N demultiplexers 210₁-210_{N}, N drop-only fabrics 220₁-220_{N}, a photonic cross-connect switch 230, a first set of M combiners 440₁-440_{M}, and a second set of M combiners 450₁-450_{M}.

The N incoming fibers 110₁-110_{N} are coupled to the N demultiplexers 210₁-210_{N}, respectively. Each demultiplexer 210 demultiplexes the incoming optical signal from the corresponding incoming fiber 110 into its component optical data streams.

The demultiplexed optical data streams from each of the N demultiplexers 210₁-210_{N} are fed into the N drop-only fabrics 220₁-220_{N}, respectively. Each drop-only fabric 220 processes the demultiplexed optical data streams received from the corresponding demultiplexer 210. Specifically, for each demultiplexed optical data stream, the drop-only fabric 220 either drops or passes the optical data stream.

The passed optical data streams from each of the N drop-only fabrics 220₁-220_{N} are fed into the photonic cross-connect switch 230. The photonic cross-connect switch 230 switches each optical data stream from an input port to an output port of the photonic cross-connect switch 230.

The switched optical data streams from the photonic cross-connect switch 230 are fed into the first set of M combiners 440₁-440_{M}. Each combiner 440 combines a plurality of switched optical data signals received from the photonic cross-connect switch to form a combined optical signal. The combined optical signals from the first set of M combiners 440₁-440_{M} are fed respectively into the second set of M combiners 450₁-450_{M}, which correspond to the M outgoing fibers 120₁-120_{M}, respectively. Any new optical data stream(s) 130 to be added to a particular outgoing fiber 120 is fed into the appropriate combiner 450. Each combiner 450 combines the combined optical signal from the corresponding combiner 440 with any new optical data streams 130 and outputs the combined optical data streams over the corresponding outgoing fiber 120.

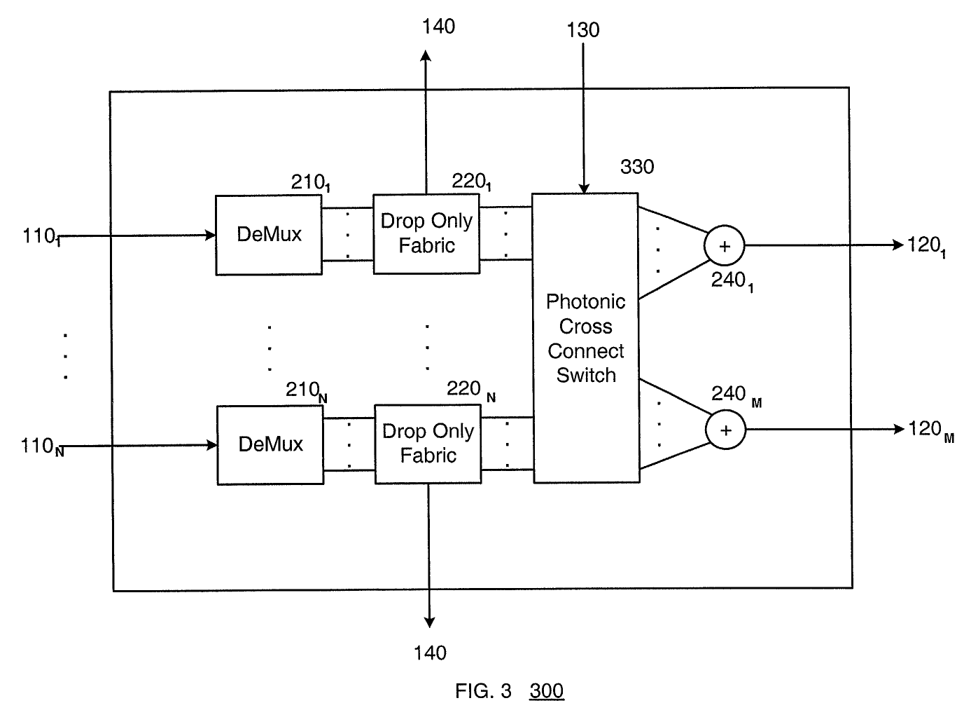

FIG. 3 is a schematic block diagram showing an exemplary photonic switch 300 in which new optical data streams are added through the photonic cross-connect switch. Among other things, the photonic switch 300 includes N demultiplexers 210₁-210_{N}, N drop-only fabrics 220₁-220_{N}, a photonic cross-connect switch 330, and M external combiners 240₁-240_{M}. The photonic cross-connect switch 330 has an extra set of input ports for receiving any new optical data streams to be added to the outgoing fibers.

The N incoming fibers 110₁-110_{N} are coupled to the N demultiplexers 210₁-210_{N}, respectively. Each demultiplexer 210 demultiplexes the incoming optical signal from the corresponding incoming fiber 110 into its component optical data streams.

The demultiplexed optical data streams from each of the N demultiplexers 210₁-210_{N} are fed into the N drop-only fabrics 220₁-220_{N}, respectively. Each drop-only fabric 220 processes the demultiplexed optical data streams received from the corresponding demultiplexer 210. Specifically, for each demultiplexed optical data stream, the drop-only fabric 220 either drops or passes the optical data stream.

The passed optical data streams from each of the N drop-only fabrics 220₁-220_{N} are fed into the photonic cross-connect switch 330. Also, any new optical data streams 130 are fed into the extra input ports of the photonic cross-connect switch 330. The photonic cross-connect switch 330 switches each optical data stream from an input port to an output port of the photonic cross-connect switch 330.

The switched optical data streams from the photonic cross-connect switch 230 are fed into the M external combiners 240₁-240_{M}, which correspond to the M outgoing fibers 120₁-120_{M}, respectively. Each external combiner 240 combines the optical data streams received from the photonic cross-connect switch 330 and outputs the combined optical data streams over the corresponding outgoing fiber 120. 5

The drop-only fabrics 220₁-220_{N} may use any of a variety of photonic switching technologies, including Micro Electro Mechanical System (MEMS) technology, Micro Opto Electro Mechanical System (MOEMS) technology, bubble (champagne) technology, lithium niobate technology, liquid crystal technology, or other photonic switching technology.

In a drop-only fabric 220 based upon MEMS or MOEMS technology, the drop-only fabric 220 may include single-sided mirrors that can be configured to drop but not add optical data streams, as described in the related application entitled SYSTEM AND APPARATUS FOR DROPPING AND ADDING OPTICAL DATA STREAMS IN AN OPTICAL COMMUNICATION NETWORK, which was incorporated by reference above. Likewise, the photonic cross-connect switches 230 and 330 may use any of a variety of photonic switching technologies, including Micro Electro Mechanical System (MEMS) technology, Micro Opto Electro Mechanical System (MOEMS) technology, bubble (champagne) technology, lithium niobate technology, liquid crystal technology, or other photonic switching technology.

The external combiners 240₁-240_{M} may be any types of optical combiner including optical couplers or multiplexers. The external combiners 240₁-240_{M} may be passive devices that do not include filter logic for preventing interference between the various optical data streams or active devices that include filter logic for preventing interference between the various optical data streams.

In a typical embodiment of the present invention, the photonic switch is coupled to two incoming fibers and to two outgoing fibers. Because it is typical for twenty percent or less of the wavelengths to be dropped or added at a particular node in an optical communication network, the total number of optical data streams that can be dropped or added by the photonic switch preferably is limited to approximately one half of the total number of wavelengths. In this way, the size of the photonic switch is substantially equal to the size and cost of an add/drop multiplexer capable of adding and dropping all wavelengths.

The present invention may be embodied in other specific forms without departing from the true scope of the invention. The described embodiments are to be considered in all respects only as illustrative and not restrictive.

What is claimed is:

1. A photonic switching system comprising:
demultiplexing logic for demultiplexing optical data streams from a plurality of incoming fibers;
dropping/passing logic operably coupled to the demultiplexing logic for receiving the demultiplexed optical data streams from the demultiplexing logic and selectively dropping or passing each demultiplexed optical data stream;
photonic switching logic opererably coupled to the dropping/passing logic for receiving the passed optical data streams from the dropping/passing logic and switching each passed optical data stream to an output port of the photonic switching logic; and
combining logic operably coupled to combine the switched optical data streams from the photonic switching logic with a number of new optical data streams to form a plurality of outgoing optical signals.

2. The photonic switching system of claim 1, wherein the demultiplexing logic comprises a plurality of demultiplexers, each demultiplexer couplable to an incoming fiber for demultiplexing optical data streams from the incoming fiber.

3. The photonic switching system of claim 1, wherein the dropping/passing logic comprises a plurality of drop-only fabrics, each drop-only fabric operably coupled to receive a plurality of demultiplexed optical data streams from the demultiplexing logic and selectively drop or pass each demultiplexed optical data stream.

4. The photonic switching system of claim 1, wherein the combining logic comprises a plurality of combiners, each combiner operably coupled to combine a plurality of switched optical data streams from the photonic cross-connect switch with a number of new optical data streams to form an outgoing optical signal.

5. The photonic switching system of claim 1, wherein the combining logic comprises:
first combiners, each of said first combiners operably coupled to combine a plurality of switched optical data streams from the photonic cross-connect switch to form a combined optical signal; and
second combiners, each of said second combiners operably coupled to combine the combined optical signal from a corresponding first combiner with a number of new optical data streams to form an outgoing optical signal.

6. A photonic switching apparatus comprising:
demultiplexing logic for demultiplexing optical data streams from a plurality of incoming fibers;
dropping/passing logic operably coupled to the demultiplexing logic for receiving the demultiplexed optical data streams from the demultiplexing logic and selectively dropping or passing each demultiplexed optical data stream;
photonic switching logic opererably coupled to the dropping/passing logic for receiving the passed optical data streams from the dropping/passing logic and switching each passed optical data stream to an output port of the photonic switching logic; and
combining logic operably coupled to combine the switched optical data streams from the photonic switching logic with a number of new optical data streams to form a plurality of outgoing optical signals.

7. The photonic switching apparatus of claim 6, wherein the demultiplexing logic comprises a plurality of demultiplexers, each demultiplexer couplable to an incoming fiber for demultiplexing optical data streams from the incoming fiber.

8. The photonic switching apparatus of claim 6, wherein the dropping/passing logic comprises a plurality of drop-only fabrics, each drop-only fabric operably coupled to receive a plurality of demultiplexed optical data streams from the demultiplexing logic and selectively drop or pass each demultiplexed optical data stream.

9. The photonic switching apparatus of claim 6, wherein the combining logic comprises a plurality of combiners, each combiner operably coupled to combine a plurality of switched optical data streams from the photonic cross-connect switch with a number of new optical data streams to form an outgoing optical signal.

10. The photonic switching apparatus of claim 6, wherein the combining logic comprises:
first combiners, each of said first combiners operably coupled to combine a plurality of switched optical data streams from the photonic cross-connect switch to form a combined optical signal; and
second combiners, each of said second combiners operably coupled to combine the combined optical signal from a corresponding first combiner with a number of new optical data streams to form an outgoing optical signal.

11. A photonic switching system comprising:
demultiplexing logic for demultiplexing optical data streams from a plurality of incoming fibers;
dropping/passing logic operably coupled to the demultiplexing logic for receiving the demultiplexed optical data streams from the demultiplexing logic and selectively dropping or passing each demultiplexed optical data stream;
photonic switching logic opererably coupled to receive the passed optical data streams from the dropping/passing logic and a number of new optical data streams and to switch each of said optical data streams to an output port of the photonic switching logic; and
combining logic operably coupled to combine the switched optical data streams from the photonic switching logic to form a plurality of outgoing optical signals.

12. The photonic switching system of claim 11, wherein the demultiplexing logic comprises a plurality of demultiplexers, each demultiplexer couplable to an incoming fiber for demultiplexing optical data streams from the incoming fiber.

13. The photonic switching system of claim 11, wherein the dropping/passing logic comprises a plurality of drop-only fabrics, each drop-only fabric operably coupled to receive a plurality of demultiplexed optical data streams from the demultiplexing logic and selectively drop or pass each demultiplexed optical data stream.

14. The photonic switching system of claim 11, wherein the combining logic comprises a plurality of combiners, each combiner operably coupled to combine a plurality of switched optical data streams from the photonic cross-connect switch to form an outgoing optical signal.

15. A photonic switching apparatus comprising:
demultiplexing logic for demultiplexing optical data streams from a plurality of incoming fibers;
dropping/passing logic operably coupled to the demultiplexing logic for receiving the demultiplexed optical data streams from the demultiplexing logic and selectively dropping or passing each demultiplexed optical data stream;
photonic switching logic opererably coupled to receive the passed optical data streams from the dropping/passing logic and a number of new optical data streams and to switch each of said optical data streams to an output port of the photonic switching logic; and
combining logic operably coupled to combine the switched optical data streams from the photonic switching logic to form a plurality of outgoing optical signals.

16. The photonic switching apparatus of claim 15, wherein the demultiplexing logic comprises a plurality of demultiplexers, each demultiplexer couplable to an incoming fiber for demultiplexing optical data streams from the incoming fiber.

17. The photonic switching apparatus of claim 15, wherein the dropping/passing logic comprises a plurality of drop-only fabrics, each drop-only fabric operably coupled to receive a plurality of demultiplexed optical data streams from the demultiplexing logic and selectively drop or pass each demultiplexed optical data stream.

18. The photonic switching apparatus of claim 15, wherein the combining logic comprises a plurality of combiners, each combiner operably coupled to combine a plurality of switched optical data streams from the photonic cross-connect switch to form an outgoing optical signal.
